(19) United States
(12) Patent Application Publication
(10) Pub. No.: US 2026/0243077 A1
(43) Pub. Date: Aug. 20, 2026

(54) Handheld Toilet Bolt Cutting Device

(71) Applicant: Sunmax Products, Inc., ChangHwa (TW)

(72) Inventors: Ying-Yu Chen, ChangHwa (TW); Lu-Fan Chen, ChangHwa (TW)

(21) Appl. No.: 19/540,539

(22) Filed: Feb. 13, 2026

Related U.S. Application Data
(60) Provisional application No. 63/760,656, filed on Feb. 20, 2025.

(51) Int. Cl. E03D 9/08; B26D 3/16; E03D 11/13; E03D 11/16

(52) U.S. Cl. CPC E03D 9/08; B26D 3/169; E03D 11/13; E03D 11/16

(57) ABSTRACT

A handheld toilet bolt cutting device is provided. The handheld toilet bolt cutting device includes a gripping component, a driving component and a cutting component. The gripping component includes a battery holder and a control circuit board. The control circuit board is coupled to the battery holder. The driving component is connected to the gripping component. The driving component has a drive motor and a transmission mechanism. The cutting component is connected to the driving component, and the cutting component has a cutting blade and a fixing base. The cutting blade is disposed inside the fixing base and connected to the transmission mechanism. The fixing base has a positioning hole and a moving groove. The moving groove is adapted to a moving member, causing the fixing base to move along the moving groove.

### CROSS-REFERENCE TO RELATED APPLICATION

This application claims priority from the U.S.A Provisional Application No. 63/760,656, filed on February 20, 2025, in the United States Patent and Trademark Office, the disclosures of which are hereby incorporated by reference in their entirety for all purposes.

### BACKGROUND OF THE INVENTION

### Field of the Invention

The present invention generally relates to a handheld toilet bolt cutting device, and in particular, to the quick, safe and convenient cutting device for cutting off the excess part of the toilet bolt.

### Description of the Related Art

Toilet bolts are key hardware components used to secure the toilet base to the floor flange. They are typically used in pairs and are usually made of corrosion-resistant brass or stainless steel. These bolt kits include bolts, nuts, washers, and decorative caps, commonly 1/4 or 5/16 inch in size, with the length depending on the floor thickness. Proper installation ensures a stable toilet and prevents leaks. The standard length of the toilet bolt is typically 3.5 inches to 4 inches to ensure that there is still enough length to tighten the nut after it is driven into the ground. The user usually choose a longer length so that it can be cut easily.

After installing toilet bolts, the excess parts are usually cut off or broken off with a saw and pliers. However, the space for installing toilet seats is often quite small. This is difficult to do in a confined space and is very inconvenient to use manpower.

In summary, the conventional way of removing the excess part of the toilet bolt still has considerable problems. Hence, the present disclosure provides the handheld toilet bolt cutting device to resolve the shortcomings of conventional technology and promote industrial practicability.

### SUMMARY OF THE INVENTION

In view of the aforementioned technical problems, the primary objective of the present disclosure is to provide the handheld toilet bolt cutting device, which are capable of cutting the excess part of the toilet bolt in a fast, safe and convenient way.

In accordance with one objective of the present disclosure, a handheld toilet bolt cutting device is provided. The handheld toilet bolt cutting device includes a gripping component, a driving component and a cutting component. The gripping component includes a battery holder and a control circuit board. The battery holder contains a rechargeable battery, and the control circuit board is coupled to the battery holder for providing electricity. A switch is disposed on one side surface of the gripping component and coupled to the control circuit board. The driving component is connected to the gripping component. The driving component has a drive motor and a transmission mechanism. The drive motor receives a control signal from the control circuit board for driving the transmission mechanism to rotate. The cutting component is connected to the driving component, and the cutting component has a cutting blade and a fixing base. The cutting blade is disposed inside the fixing base and connected to the transmission mechanism. The fixing base has a positioning hole and a moving groove. The positioning hole passes through the fixing base to form a cutting area for placing a toilet bolt. The moving groove is adapted to a moving member of the cutting blade, causing the fixing base to move along the moving groove and the cutting blade entering the cutting area to cut the toilet bolt.

Preferably, the rechargeable battery may include a lithium battery.

Preferably, the drive motor may include a brushed DC motor or a brushless DC motor.

Preferably, the transmission mechanism may include a first gear unit and a second gear unit, a first rotating shaft of the first gear unit is connected to the drive motor, the second gear unit is connected to the first gear unit, and a second rotating shaft of the second gear unit is connected to the cutting blade.

Preferably, the fixing base is manually moved along the moving groove.

Preferably, the fixing base is electrically moved along the moving groove.

As mentioned previously, the handheld toilet bolt cutting device may have one or more advantages as follows.
1. The handheld toilet bolt cutting device may use an electric handheld device to cut the toilet bolt. This eliminates the need for using the manual sawing or pliers. The cutting process no longer limited by the size of the operating area. Based on the electric handheld device, the cutting process is easier to achieve and implement.
2. The handheld toilet bolt cutting device may use the drive motor and the transmission mechanism to drive the cutting blade. The cutting process is faster and more effortless.
3. The handheld toilet bolt cutting device may cut the toilet bolt with the same cutting height determined by the thickness of the fixing base. The cutting results are aesthetically pleasing and consistent.

### BRIEF DESCRIPTION OF THE DRAWINGS

The technical features, detail structures, advantages and effects of the present disclosure will be described in more details hereinafter with reference to the accompanying drawings that show various embodiments of the invention as follows.

FIG. 1 is schematic diagrams of the handheld toilet bolt cutting device in accordance with the embodiment of the present disclosure.

FIG. 2 is schematic side view diagram of the handheld toilet bolt cutting device in accordance with the embodiment of the present disclosure.

FIG. 3 is another schematic side view diagram of the handheld toilet bolt cutting device in accordance with the embodiment of the present disclosure.

### DETAILED DESCRIPTION OF THE PREFERRED EMBODIMENTS

In order to facilitate the understanding of the technical features, the contents and the advantages of the present disclosure, and the effectiveness thereof that can be achieved, the present disclosure will be illustrated in detail below through embodiments with reference to the accompanying drawings. The diagrams used herein are merely intended to be schematic and auxiliary to the specification, but are not necessary to be true scale and precise to the configuration after implementing the present disclosure. Thus, it should not be interpreted in accordance with the scale and the configuration of the accompanying drawings to limit the scope of the present disclosure on the practical implementation.

As those skilled in the art would realize, the described embodiments may be modified in various different ways. The exemplary embodiments of the present disclosure are for explanation and understanding only. The drawings and description are to be regarded as illustrative in nature and not restrictive. Similar reference numerals designate similar elements throughout the specification.

It is to be acknowledged that, although the terms ‘first’, ‘second’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term "or" includes any and all combinations of one or more of the associated listed items.

It will be acknowledged that when an element or layer is referred to as being "on," "connected to" or "coupled to" another element or layer, it can be directly on, connected or coupled to the other element or layer, or intervening elements or layers may be present. In contrast, when an element is referred to as being "directly on," "directly connected to" or "directly coupled to" another element or layer, there are no intervening elements or layers present.

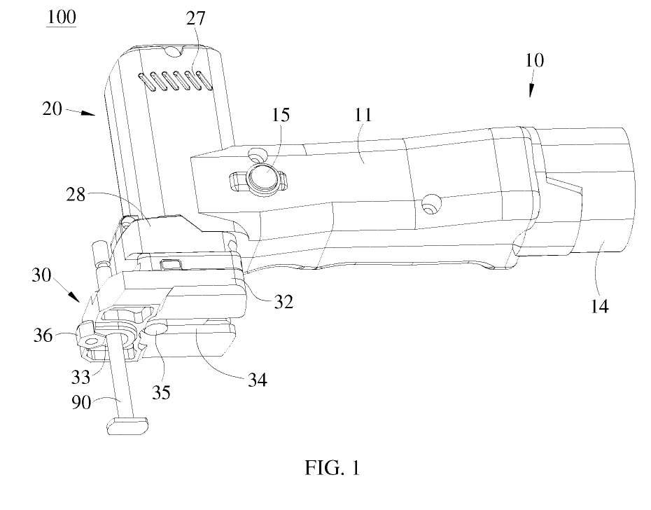

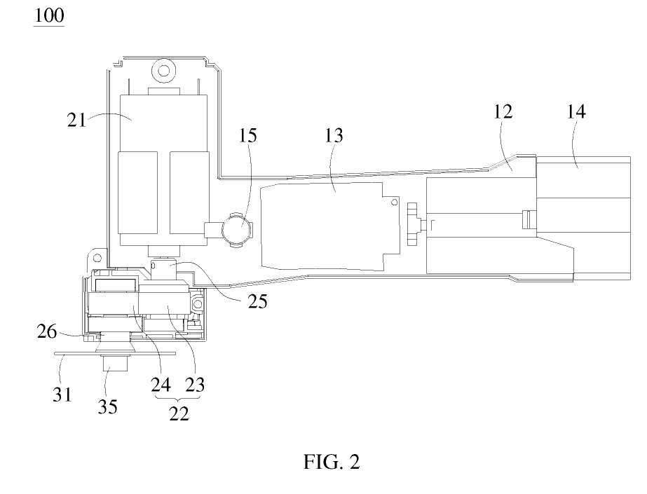

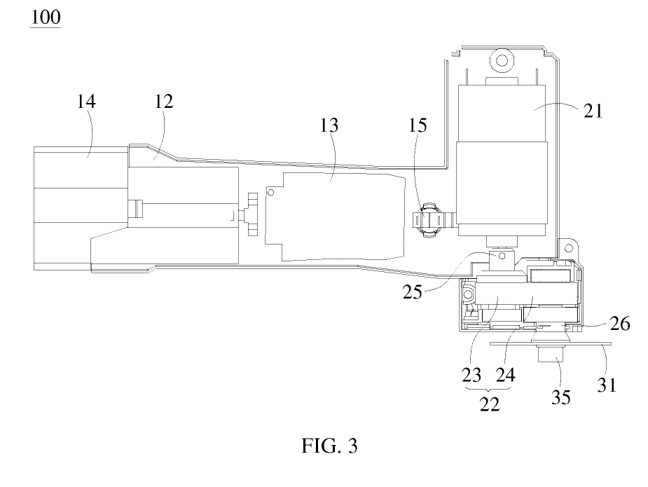

Please refer to FIG. 1 to FIG. 3, FIG. 1 is schematic diagrams of the handheld toilet bolt cutting device in accordance with the embodiment of the present disclosure, FIG. 2 is schematic side view diagram of the handheld toilet bolt cutting device in accordance with the embodiment of the present disclosure, and FIG. 3 is another schematic side view diagram of the handheld toilet bolt cutting device in accordance with the embodiment of the present disclosure.

As shown in the figures, the handheld toilet bolt cutting device 100 includes a gripping component 10, a driving component 20 and a cutting component 30. The gripping component 10 is an elongated shape casing 11. The surface of the casing 11 may have irregularities to provide a comfortable grip for the user. The gripping component 10 includes a battery holder 12 and a control circuit board 13. The battery holder 12 and the control circuit board 13 are disposed inside the casing 11. The battery holder 12 has an opening in one side of the casing 11 for contains a rechargeable battery 14. The rechargeable battery 14 may include a lithium battery. The battery voltage can be 3.6V to 4.2V. In other embodiments, the battery voltage can be 12V or 18V. The control circuit board 13 is coupled to the battery holder 12. By inserting the rechargeable battery 14 into the battery holder 12, the electricity is supplied to the control circuit board 13, thereby providing the handheld toilet bolt cutting device 100 with the necessary power.

A switch 15 is disposed on one side surface of the gripping component 10. The switch 15 has a button and switch circuit. The button protrudes from the surface of the casing 11, providing users with pressure control. The switch circuit connects to the control circuit board 13 and the button connects to the switching circuit. The handheld toilet bolt cutting device 100 is turning on or off when the button is pressed by the user.

The driving component 20 is connected to the gripping component 10. The driving component 20 may has an outer shell extending from the casing 11. The driving component 20 has a drive motor 21 and a transmission mechanism 22. The drive motor 21 and the transmission mechanism 22 are disposed inside the outer shell. The drive motor 21 may include a brushed DC motor or a brushless DC motor. The control circuit board 13 sends control signal for driving the drive motor 21 to rotate. The transmission mechanism 22 is connected to the drive motor 21. When the drive motor 21 starts to rotate, the transmission mechanism 22 is actuated by the drive motor 21.

The transmission mechanism 22 includes a first gear unit 23 and a second gear unit 24. The first gear unit 23 is connected to the drive motor 21. In the present embodiment, the first gear unit 23 has a first rotating shaft 25 and the first rotating shaft 25 of the first gear unit 23 is connected to the drive motor 21. The second gear unit 24 is connected to the first gear unit 23. The first gear unit 23 and the second gear unit 24 may have the same or different gear ratios. The second gear unit 24 has a second rotating shaft 26 and the second rotating shaft 26 of the second gear unit 24 is connected to the cutting blade 31. In the present embodiment, the two gear units are arranged in parallel to determine the rotational speed and torque of the cutting blade 31. However, the present disclosure is not limited to this. The different numbers of gear units or different configurations should also be included within the scope of the present disclosure.

The outer shell covers the drive motor 21. One or more heat dissipation holes 27 can be provided on the surface of the casing. A protective shell 28 can also be disposed outside the transmission mechanism 22. When the handheld toilet bolt cutting device 100 is started, the shell body protects the user from the high-speed rotating mechanism, while the encasing shell reduces rotational noise.

The cutting component 30 is connected to the driving component 20. The cutting component 30 has a cutting blade 31 and a fixing base 32. The cutting blade 31 is disposed inside the fixing base 32 and connected to the transmission mechanism 22. As mentioned above, the cutting blade 31 is connected to the second rotating shaft 26 of the second gear unit 24. The fixing base 32 is made into a square or rectangular shape. The fixing base 32 has a positioning hole 33 and a moving groove 34. The positioning hole 33 is disposed at one side of the fixing base 32. Approximately one nut's distance from the side of the fixing base 32. The positioning hole 33 passes through the fixing base 32 to form a cutting area for placing a toilet bolt 90. The size of the positioning hole 33 is slightly larger than that of the toilet bolt 90.

The moving groove 34 is disposed in other side of the fixing base 32. The moving groove 34 is a groove-shaped opening extending from the center to the side of the fixing base 32. The moving groove 34 is adapted to a moving member 35 of the cutting blade 31. That is, the extending part of the cutting blade 31 is located in the moving groove 34 and reciprocated along the moving groove 34. By limiting the movement of the moving member 35, the fixing base 32 can be moved along the moving groove 34 and the cutting blade 31 may enter the cutting area to cut the toilet bolt 90. In the present embodiment, some limiting structure can be disposed between the protective shell 28 and the fixing base 32. Based on the limiting structure, the fixing base 32 will move in the predetermined direction.

After the toilet bolt 90 is installed, the excess screw length needs to be removed. The user may grip the handheld toilet bolt cutting device 100 and fit the positioning hole 33 onto the toilet bolt 90. The cutting height can be determined based on the thickness of the fixing base 32. In other embodiment, a nut 36 is disposed adjacent to the positioning hole 33. The nut 36 may provide a pre-set height to adjust the cutting height. After determining the cutting position, the user may push the bottom to start the handheld toilet bolt cutting device 100. The control circuit board 13 starts up and sends control signal to start the drive motor 21. The cutting blade 31 begins to rotate via the transmission mechanism 22.

The fixing base 32 and the positioning hole 33 are fixed by the toilet bolt 90. When the handheld toilet bolt cutting device 100 moves in the moving groove 34 by means of the moving part 35, the cutting blade 32 moves toward the cutting area to cut the toilet bolt 90. In the present embodiment, the fixing base 32 is manually moved along the moving groove 34. That is, the user may apply force to move the handheld toilet bolt cutting device 100 toward the toilet bolt 90. Then the cutting blade 32 moves toward the cutting area to cut the toilet bolt 90. In other embodiment, the fixing base 32 may install electric device. When the user push the start bottom, the fixing base 32 is automatically moved along the moving groove 34 by the electric device. The cutting process is completed automatically without the need for additional force. The cutting process only needs 5 to 10 seconds, which is faster and more convenient than traditional sawing or breaking methods.

The present disclosure disclosed herein has been described by means of specific embodiments. However, numerous modifications, variations and enhancements can be made thereto without departing from the spirit and scope of the disclosure set forth in the claims.

What is claimed is:

1. A handheld toilet bolt cutting device comprising:
a gripping component, comprising a battery holder and a control circuit board, the battery holder containing a rechargeable battery, the control circuit board being coupled to the battery holder for providing electricity, a switch being disposed on one side surface of the gripping component and coupled to the control circuit board;
a driving component connected to the gripping component, the driving component having a drive motor and a transmission mechanism, the drive motor receiving a control signal from the control circuit board for driving the transmission mechanism to rotate; and
a cutting component connected to the driving component, the cutting component having a cutting blade and a fixing base, the cutting blade being disposed inside the fixing base and connected to the transmission mechanism, the fixing base having a positioning hole and a moving groove, the positioning hole passing through the fixing base to form a cutting area for placing a toilet bolt, the moving groove being adapted to a moving member of the cutting blade, causing the fixing base to move along the moving groove and the cutting blade entering the cutting area to cut the toilet bolt.

2. The handheld toilet bolt cutting device of claim 1, wherein the rechargeable battery comprises a lithium battery.

3. The handheld toilet bolt cutting device of claim 1, wherein the drive motor comprises a brushed DC motor or a brushless DC motor.

4. The handheld toilet bolt cutting device of claim 1, wherein the transmission mechanism comprises a first gear unit and a second gear unit, a first rotating shaft of the first gear unit is connected to the drive motor, the second gear unit is connected to the first gear unit, and a second rotating shaft of the second gear unit is connected to the cutting blade.

5. The handheld toilet bolt cutting device of claim 1, wherein the fixing base is manually moved along the moving groove.

6. The handheld toilet bolt cutting device of claim 1, wherein the fixing base is electrically moved along the moving groove.
